(19) United States
(12) Patent Application Publication
(10) Pub. No.: US 2025/0342073 A1
(43) Pub. Date: Nov. 6, 2025

(54) COMPUTER-READABLE RECORDING MEDIUM HAVING STORED THEREIN PERFORMANCE INFORMATION COLLECTING PROGRAM, METHOD FOR COLLECTING PERFORMANCE INFORMATION, AND INFORMATION PROCESSING APPARATUS

(71) Applicant: Fujitsu Limited, Kawasaki-shi (JP)

(72) Inventor: Mari YAMAOKA, Minato (JP)

(73) Assignee: Fujitsu Limited, Kawasaki-shi (JP)

(21) Appl. No.: 19/176,682

(22) Filed: Apr. 11, 2025

(30) Foreign Application Priority Data
May 2, 2024 (JP) 2024-074808

(51) Int. Cl. G06F 11/00

(52) U.S. Cl. CPC G06F 11/004; G06F 2201/81

(57) ABSTRACT

A computer-readable recording medium has stored therein a program for causing a computer to execute a process for collecting performance information, the process including: obtaining one or more pieces of related information related to each of a plurality of processes, including a first process and a second process, to be executed in an information processing apparatus, calculating one or more hash values of each of the plurality of processes by inputting each of values of the one or more pieces of the related information obtained for each of the plurality of processes into respective corresponding hash functions, and when the plurality of hash values calculated for the first process at least partially match the plurality of hash values calculated for the second process, measuring, while the second process is being executed, second performance information at least partly different from first performance information, the first information being measured while the first process is being executed.

### CROSS-REFERENCE TO RELATED APPLICATION

This application is based upon and claims the benefit of priority of the prior Japanese Patent application No. 2024-074808, filed on May 2, 2024, the entire contents of which are incorporated herein by reference.

### FIELD

The embodiment discussed herein relates to a computer-readable recording medium having stored therein performance information collecting program, a method for collecting performance information, and an information processing apparatus.

### BACKGROUND

A system performance analysis has been known which finds a reason for performance degradation on the basis of performance information obtained from an information processing apparatus. A technique is known which, in order to suppress shortage onto a database due to increasing data volume of performance information to be stored, calculates a correlation function between performance information and model data at constant intervals and omits storing of the performance information having a correlation function higher than a threshold.

For example, a related art is disclosed in Japanese Laid-Open Patent Publication No. 2004-104154.

### SUMMARY

According to an aspect of the embodiments, the non-transitory computer-readable recording medium has stored therein a program for causing a computer to execute a process for collecting performance information, the process including: obtaining one or more pieces of related information related to each of a plurality of processes, including a first process and a second process, to be executed in an information processing apparatus, calculating one or more hash values of each of the plurality of processes by inputting each of values of the one or more pieces of the related information obtained for each of the plurality of processes into respective corresponding hash functions, and when the plurality of hash values calculated for the first process at least partially match the plurality of hash values calculated for the second process, measuring, while the second process is being executed, second performance information at least partly different from first performance information, the first information being measured while the first process is being executed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a system according to an embodiment;

FIG. 2 is a block diagram schematically illustrating an example of a hardware configuration of a computer achieving a target server in the one embodiment;

FIG. 3 is a diagram illustrating system performance analysis in the system in FIG. 1;

FIG. 4 is a diagram illustrating a relationship between the counter number and the number of types of performance information in the target server in a first comparative example;

FIG. 5 is a diagram illustrating an example a relationship between multiple pieces of performance information and a performance information set in the one embodiment;

FIG. 6 is a diagram illustrating an example of a performance information collecting process by a target server in the one embodiment;

FIG. 7 is a diagram illustrating a manner of a process identity determination in a second comparative example;

FIG. 8 is a block diagram illustrating an example of

a functional configuration of the target server in the one embodiment;

FIG. 9 is a diagram illustrating an example of a

process identity determining process performed by the target server in the one embodiment;

FIG. 10 is a diagram illustrating an example of a result of the process identity determination;

FIG. 11 is a diagram illustrating an example of a priority table that defines a priority of each piece of related information;

FIG. 12 is a diagram illustrating an example of a measuring process of performance information performed by the target server in the one embodiment;

FIG. 13 is a diagram illustrating a first example that uses an environment variable as the related information;

FIG. 14 is a diagram illustrating a result of calculating a hash value in the first example;

FIG. 15 is a diagram illustrating a second example that uses memory map information as the related information;

FIG. 16 is a diagram illustrating a result of calculating a hash value in the second example;

FIG. 17 is a diagram illustrating a third example that uses the number of times each execution address is used as a value of the related information;

FIG. 18 is a diagram illustrating the third example that uses the number of times each execution address is used as a value of the related information;

FIG. 19 is a diagram illustrating a result of calculating a hash value in the third example;

FIG. 20 is a flow chart illustrating an example of operation of a performance information collecting process performed by the target server in the one embodiment;

FIG. 21 is a flow chart illustrating an example of operation of a process identity determining process performed by the target server in the one embodiment;

FIG. 22 is a flow chart illustrating an example of operation of a target information storing and hash value comparing process performed by the target server in the one embodiment; and

FIG. 23 is a flow chart illustrating an example of

operation of a performance information selecting and measuring process performed by the target server in the one embodiment.

### DESCRIPTION OF EMBODIMENT(S)

As the number of types of performance information to be measured increases, the information processing apparatus serving as a target for the performance analysis would have increasing load of measuring performance information and also increasing load of transmitting the performance information to an analyzer device.

Hereinafter, the embodiment of the present disclosure will be described, referring to the accompanying drawings. However, the embodiment described below is merely exemplary and is not intended to exclude the application of various modifications and techniques not explicitly described below. For example, the present embodiment can be variously modified and implemented without departing from the scope thereof. In the drawings used in the following description, the same reference numbers denote the same or similar elements, unless otherwise specified.

### A. Description of one Example of System

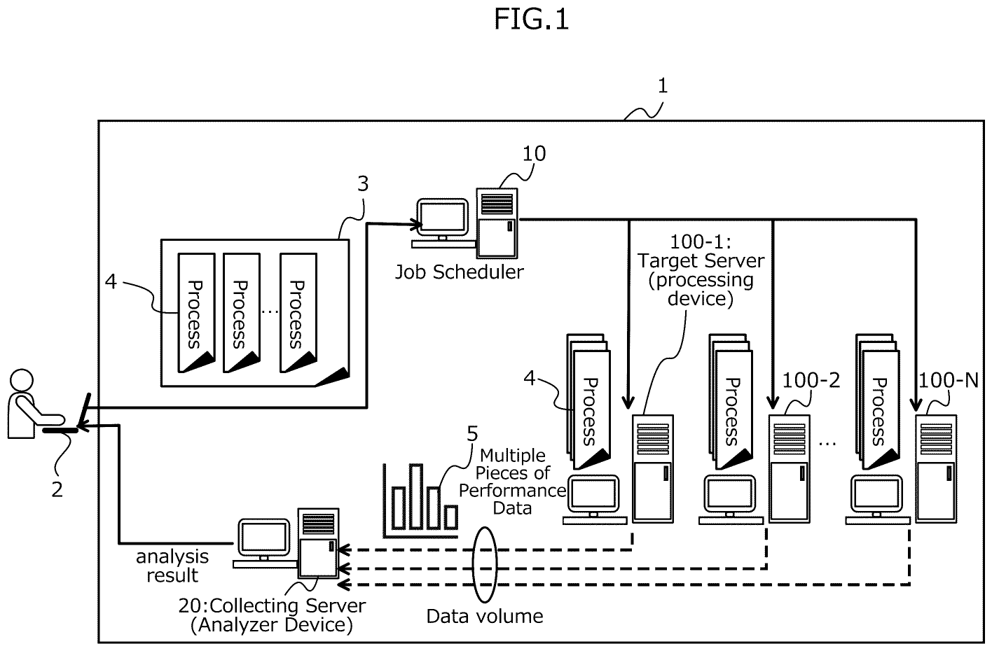

FIG. 1 is a diagram illustrating an example of a configuration of a system 1 according to an embodiment. As will be described below, the system 1 of the present embodiment determines the identity between processes to be executed on the basis of a colliding state (i.e., identity) of hash values obtained by inputting values of related information related to respective processes 4 into a hash function. Hereinafter, a process contents will now be detailed.

The system 1 processes a job 3 inputted from, for example, a user terminal 2. The job 3 is a unit of a process inputted from a shell constituting an OS (Operating System).

The job 3 includes multiple processes 4. The process 4 may be a program that is in a running state on a memory, and is a unit of a process from the perspective of a kernel constituting the OS. The process 4 is also referred to as a computation process. A current process 4 may be referred to as a process 4-i, and one or more processes 4 already executed may be referred to as preceding process 4-t. A preceding process 4-t is an example of a first process and an current process 4-i is an example of a second process. In one example, the second process is a subsequent process that follows the preceding process 4-t.

The system 1 of the present embodiment is widely used in various fields such as a quantum simulator field and a High Performance Computing (HPC) field. In particular, jobs 3 in the quantum simulator field and the HPC field tends to repeat execution of multiple common processes 4. Utilizing the above tendency, the system 1 reduces data volume exchanged between multiple target servers 100 and a collecting server 20.

In the example illustrated in FIG. 1, the system 1 includes a job scheduler 10, the collecting server 20, and multiple target servers 100-1, 100-2, . . . , 100-N (sometimes collectively referred to as target servers 100).

The job scheduler 10 controls starting and ending of multiple jobs 3 in the system 1. The job scheduler 10 may monitor or report the execution state and the ended state of a job 3. In one example, the job scheduler 10 is referred to as a job administration system.

The collecting server 20 collects multiple pieces of performance information 5 from respective target servers 100. The collecting server 20 performs system performance analyses based on multiple pieces of collected performance information 5. The result of system performance analyses may be reported to the user through a user terminal 2, for example.

A target server 100 is an example of an information processing apparatus that executes a process 4 included in a job 3. Multiple target servers 100 constitute a target server group. A target server 100 is an information processing apparatus serving as an object of system performance analysis. The configuration of a target server 100 is illustrated by referring to a target server 100-1 as an example. The configurations of the target servers 100-2 to 100-N are the same as the configuration of the target server 100-1.

### B. Example of Hardware Configuration

The function of the target server 100 of the one embodiment may be achieved by one computer or by two or more computers. Further, at least a part of the functions of the server 1 may be implemented using Hardware (HW) resources and Network (NW) resources provided by cloud environment.

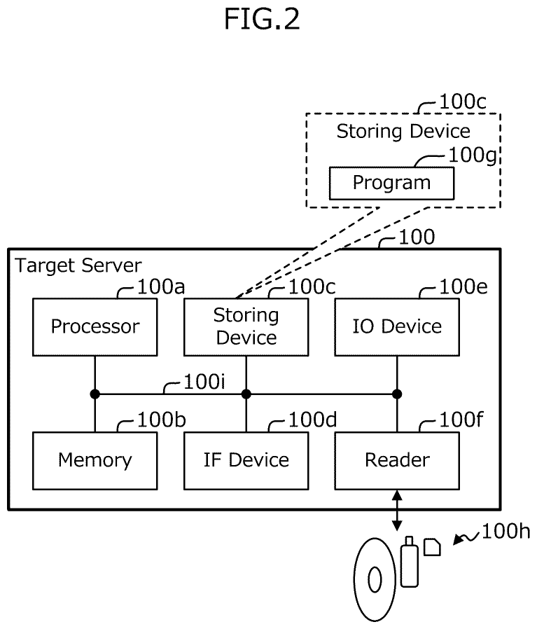

FIG. 2 is a block diagram illustrating an example of a hardware (HW) configuration of the target server 100 that achieves the function of target server 100 according to the one embodiment. If multiple computers are used as the HW resources for achieving the functions of the target server 100, each of the computers may include the HW configuration illustrated in FIG. 2.

As illustrated in FIG. 2, the target server 100 may illustratively include, as the HW configuration, a processor 100a, a memory 100b, a storing device 100c, an Interface (IF) device 100d, an Input/Output (IO) device 100e, and a reader 100f.

The processor 100a is an example of an arithmetic processing device that performs various types of control and calculations. The processor 100a may be mutually communicably connected to each of the blocks in the target server 100 via a system bus 100i. The processor 100a may be a multi-processor including multiple processors or a multi-core processor including multiple processor cores, or may have a structure including two or more multi-core processors.

The processor 100a may be any one of integrated circuits (ICs) such as CPUs (Central Processing Units), MPUs (Micro Processing Units), GPUs (Graphics Processing Units), APUs (Accelerated Processing Units), DSPs (Digital Signal Processors), ASICS (Application Specific Integrated Circuits), and FPGAS (Field Programmable Gate Arrays), or combinations of two or more of these ICs.

The memory 100b is an example of a hardware device that stores various pieces of data and information of a program. An example of the memory 100b is one of a volatile memory such as a Dynamic Random Access Memory (DRAM) and a non-volatile memory such as a persistent Memory (PM) or the both.

The storing device 100c is an example of a hardware device that stores information such as various data, programs, and the likes. Examples of the storing device 100c may be various storing devices including a magnetic disk device such as a Hard Disk Drive (HDD), a semiconductor drive device such as a Solid State Drive (SSD), a nonvolatile memory, and the like. The non-volatile memory may be, for example, a flash memory, a Storage Class Memory (SCM), a Read Only Memory (ROM), and the like.

The storing device 100c may store a program 100g (performance information collecting program) that implements all or a part of various functions of the target server 100. The program 100g may include, for example, an Operating System (OS) in addition to the performance information collecting program. As an example, the program 100g of the present embodiment may function as a daemon that operates mainly on the background in a multitask OS.

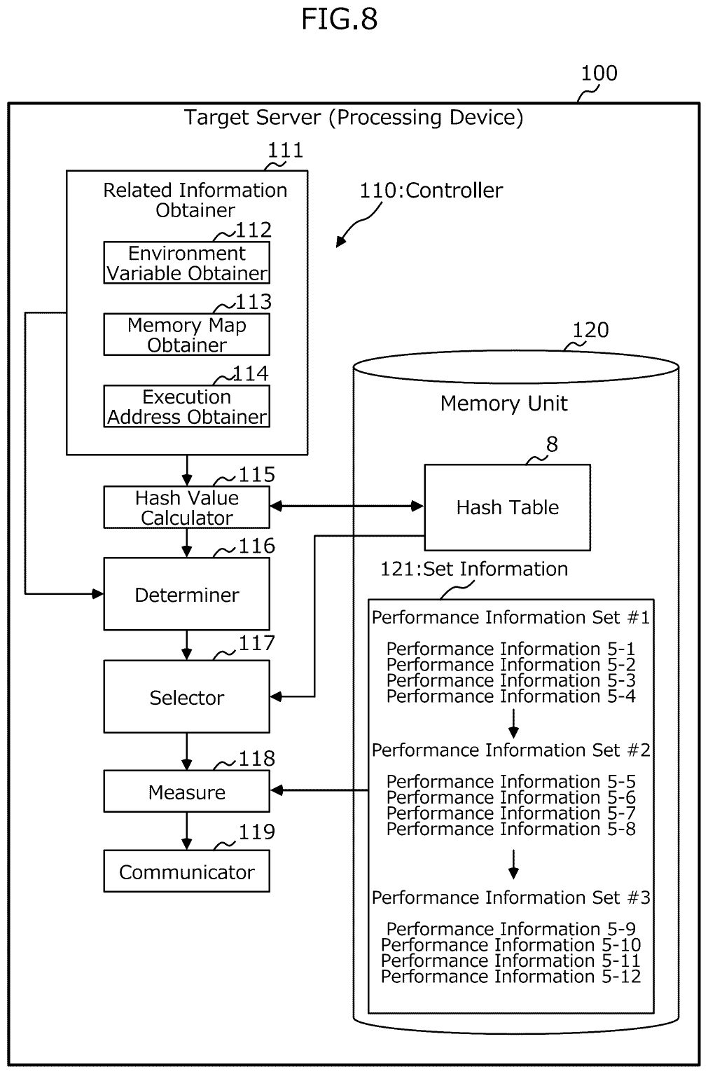

For example, the processor 100a may achieve the function of a controller (controller 110 of FIG. 8 to be detailed below) of the target server 100 by expanding the program 100g stored in the storing device 100c on the memory 100b and executing the expanded program 100g.

The target server 100 serving as an object of the system performance analysis may execute each process of performance information collection by executing, as a computer, the performance information collecting program.

The IF device 100d is an example of a communication IF that controls connections and communications between the target server 100 and other devices. Example of the other devices are a computer such as a job scheduler 10 that provides data to the target server 100 and the user terminal 2, and a computer such as the user terminal 2 that obtains data output from the target server or the collecting server 20.

For example, the IF device 100d may include an applying adapter conforming to Local Area Network (LAN) such as Ethernet® or optical communication such as Fibre Channel (FC). The applying adapter may be compatible with either or both of wireless and wired communication schemes.

Furthermore, the program 100g may be downloaded from the network to the target server 100 through the communication IF device 100d and be stored in the storing device 100c.

The IO device 100e may include one or both of an input device and an output device. Examples of the input device include a keyboard, a mouse, and a touch panel. Examples of the output device include a monitor, a projector, and a printer. The IO device 100e may include, for example, a touch panel that integrates an input device and an output device with each other.

The reader 100f is an example of a reader that reads information of data and programs recorded on a recording medium 100h. The reader 100f may include a connecting terminal or device to which the recording medium 100h may be connected or inserted. Examples of the reader 100f include an applying adapter conforming to, for example, Universal Serial Bus (USB), a drive apparatus that accesses a recording disk, and a card reader that accesses a flash memory such as an SD card. The program 100g may be stored in the recording medium 100h. The reader 100f may read the program 100g from the recording medium 100h and store the read program 100h into the storing device 100c.

Examples of the recording medium 100h illustratively include a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the target server 100 described above is exemplary. Accordingly, the target server 100 may appropriately undergo increase or decrease of HW devices (e.g., addition or deletion of arbitrary blocks), division, integration in an arbitrary combination, or addition or deletion of the bus.

### C. Description of System Performance Analysis and Performance Information

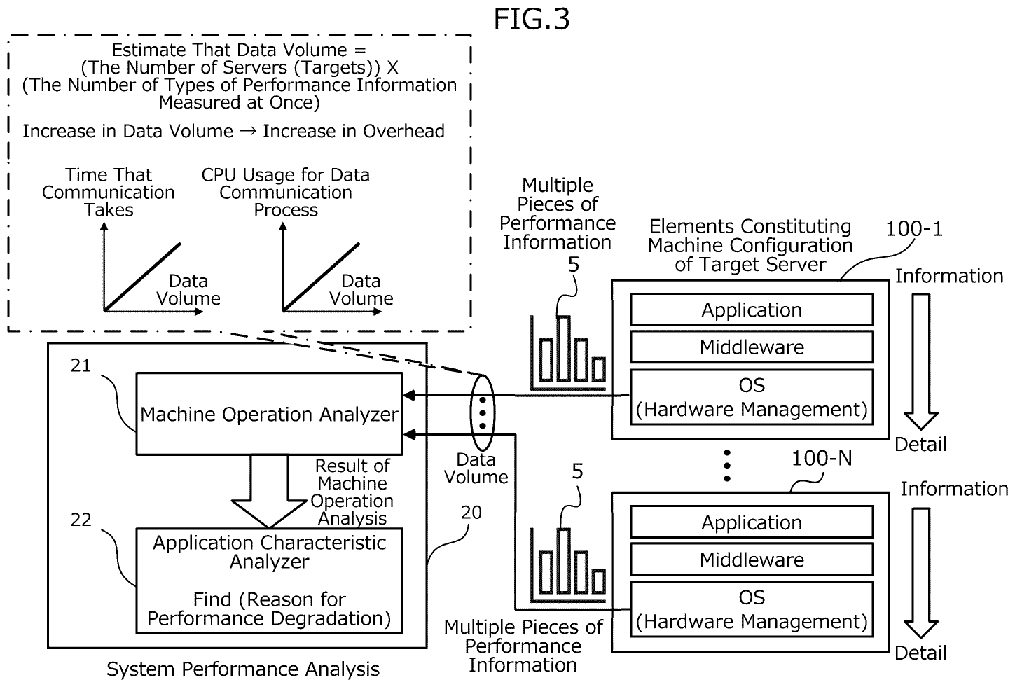

FIG. 3 is a diagram illustrating the system performance analysis in the system 1 of FIG. 1. In the target server 100, various applications operate. In the target server 100, layers of middleware and an OS exist under the application layer. Compared with information from an application and middleware, information about the hardware obtained from the OS and the information about the OS are more suitable for detailed system performance analyses. Accordingly, the target server 100 may measure (collect) multiple pieces of performance information 5 about the hardware and the OS.

Multiple pieces of performance information 5 may include an available memory size (MB) of a memory 100b, a used memory size (Byte), the number of transferred pages per second (pages per second), and a used disc size (%) of the storing device 100c of the target server 100. In addition, the performance information 5 may include the number of connected users (active session count) and a processor activity ratio (%) of the processor 100a. The performance information 5 is information when the target server 100 is executing each process 4.

The multiple pieces of performance information 5 may include an average processor activity ratio (%) of the processor 100a, a maximum processor activity ratio (%) of the processor 100a, a processor busy ratio (%) of the processor 100a, a context switch count per second, and an interrupt count per second, for example.

The multiple pieces of performance information 5 may also include the number of read pages per second, a page input count per second, a page fault count per second, and a hard page fault ratio (%) in the memory 100b. The multiple pieces of performance information 5 may include a network transfer amount (Mbyte per second), a transmission amount (MBit) per second, and a reception amount (MBit) per second in the IF device 100d, or any combination thereof. The multiple pieces of performance information 5 may include the number of storage transfers per second and the storage transfer amount (MByte) per second in the storage 100c. The multiple pieces of performance information 5 may include a host-bus transfer amount (MByte) per second in the system bus 100i.

However, the multiple pieces of performance information 5 is not limited to the above examples. The multiple pieces of performance information 5 may not include all of the above examples and may sufficiently include some of the above-described examples. The multiple pieces of performance information 5 are measured while the target server 100 is executing a process 4. The multiple pieces of measured performance information 5 are transmitted to the collecting server 20. The target server 100 may spontaneously measures the performance information 5 and transmit the measured information 5 to the collecting server 20. Alternatively, the collecting server 20 may access the target server 100 to collect the result of measuring the performance information 5 stored in the target server 100.

As illustrated in FIG. 3, the collecting server 20 includes a machine operation analyzer 21 and an application characteristic analyzer 22. The machine operation analyzer 21 analyzes the operation of the objective target server 100 on the basis of multiple pieces of collected performance information 5. The application characteristic analyzer 22 analyzes the reason for performance degradation when an application is being executed, using the result of analysis on operation performed by the target server 100. The result of the analysis is sent to the user terminal 2.

The data volume exchanged between the multiple target servers 100 and the collecting server 20 may be estimated on the basis of the product of the number of multiple target servers 100 and the number of types of performance information 5 measured by each target server 100 at once.

An increase in the data volume causes an increase in communication overhead. Specifically, as the data volume increases, a network load increases and a processor load on the collecting server 20 also increases.

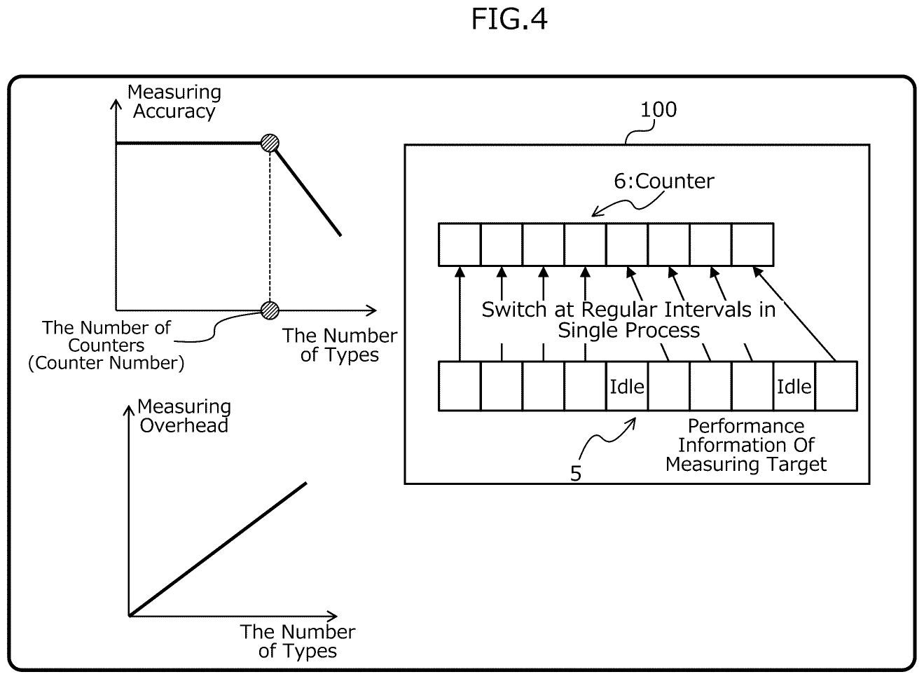

In addition, the number of types of the multiple pieces of performance information 5 affects the measurement overhead and the measurement accuracy of the performance information 5. FIG. 4 is a diagram illustrating a relationship between a counter number and a number of types of performance information 5 in the target server 100 in a first comparative example. Also in the first comparative example, the same reference numbers as in the embodiment are used for explanation.

For detailed system performance analysis, it is desirable to increase the number of types of the performance information 5. However, as the number of types of the performance information 5 to be measured increases, the process load for executing the measurement, that is, the measurement overhead, increases.

The target server 100 includes a counter 6. The counter 6 is an abstraction layer provided with an interface for measuring (collecting) the performance information 5. The counter 6 is referred to as a performance counter. In the counter 6, the counter number represents the number of types of measurement that may be taken at once.

When the number of types of performance information 5 to be measured exceeds the counter number, the measurement is carried out by switching pieces of the performance information 5 to be measured at predetermined intervals in a single current process 4. However, when pieces of the performance information 5 to be measured are switched in the single process 4, the time for a pieces of measuring performance information 5 to be switched is shortened, so that the measurement accuracy may be lowered.

The system 1 of the present embodiment reduces the load of measuring and transmitting the performance information 5 by the target server 100 while ensuring sufficient types of performance information 5 for detailed system performance analysis.

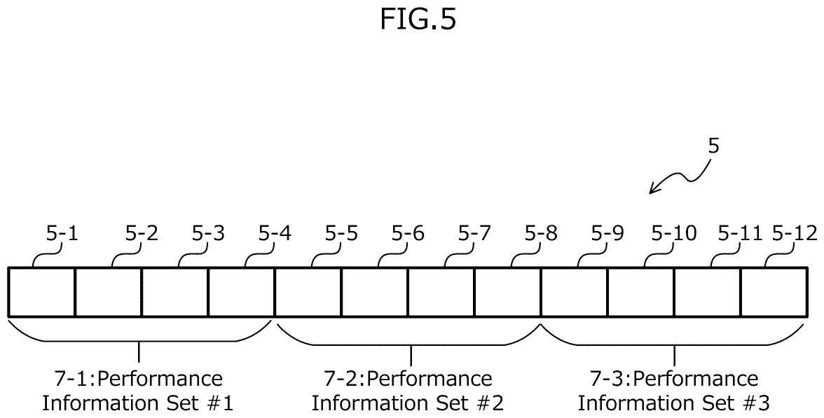

FIG. 5 is a diagram illustrating an example of a relationship between multiple pieces of performance information 5 and a performance information set 7 according to the one embodiment. In FIG. 5, the multiple pieces of performance information 5 include the performance information 5-1 to 5-12. The multiple pieces of performance information 5 are divided into multiple performance information sets 7-1 (#1), 7-2 (#2), and 7-3 (#3). Each of the performance information sets 7-1 to 7-3 (which may hereinafter be collectively referred to as performance information sets 7) includes one or more predetermined pieces of performance information 5, and is a result of measurement conducted at a time.

The number of types of the performance information 5-1 to 5-12, the number of performance information sets 7, and the type of performance information 5 included in each of the performance information sets 7 are not limited to the example illustrated in FIG. 5. The number of performance information sets 7 and the types of performance information 5 included in each performance information set 7 are predetermined.

The number of types of performance information 5 included in each performance information set 7 may be different or same with the respective performance information sets 7. The number of types of performance information 5 included in each performance information set 7 is preferably the counter number or less. When the number of types of performance information 5 included in each performance information set 7 is the counter number or less, there is no need to switch performance information 5 to be measured during a single process, so that it is possible to avoid degradation of the measurement accuracy.

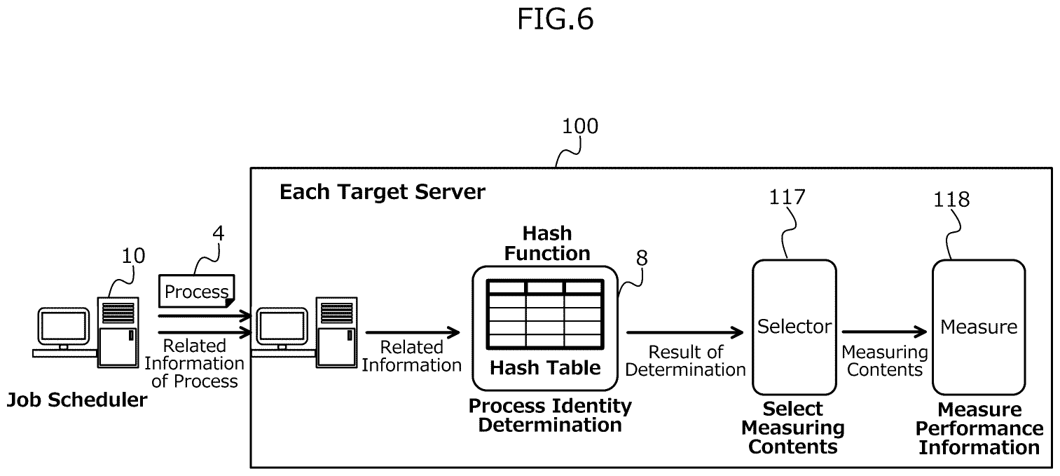

FIG. 6 is a diagram illustrating an example of a performance information collecting process performed by the target server 100 in the one embodiment. Each target server 100 receives a process 4 included in a job 3 from the job scheduler 10.

Each target server 100 obtains related information related to each process 4. The related information will be detailed below. Each target server 100 manages the value (key) of the related information and the corresponding hash value, as a set, using a data structure called a hash table 8.

A hash function is predetermined for each piece of the related information. A hash function is a function that receives an arbitrary number (key) as an input and generates an output called a hash value. A hash function outputs the same hash value in response to the same input value. A hash function outputs different hash values in response to different input values. The hash function is not particularly limited. Since a known hash function may be used, detailed description of the hash function is omitted here.

A hash value is called an index (subscript). In the hash table 8, data is stored in the position (element) identified by the hash value as an index in an array. Data may include a process name or a value of the related information, or any combination thereof. However, data stored in the hash table 8 is not limited, and no data may be stored.

The target server 100 determines the identity between a preceding process 4-t and a current process 4-i among multiple processes 4 on the basis of whether or not one or more hash values calculated for the preceding process 4-t matches one or more hash values calculated for the current process 4-i. The hash values calculated for the preceding process 4-t matching the hash values calculated for the current process 4-i means that the storing positions in the array are the same. The state where these hash values are the same between the current process 4i and the preceding process 4-t is sometimes referred to as a collision of the hash values.

When the hash values calculated for the preceding process 4-t at least partially match the hash values calculated for another process, a selector 117 selects second performance information that is at least partly different from the first performance information measured while the preceding process 4-t is being executed from among the multiple pieces of performance information 5. The measure 118 measures the selected second performance information while the other process is being executed.

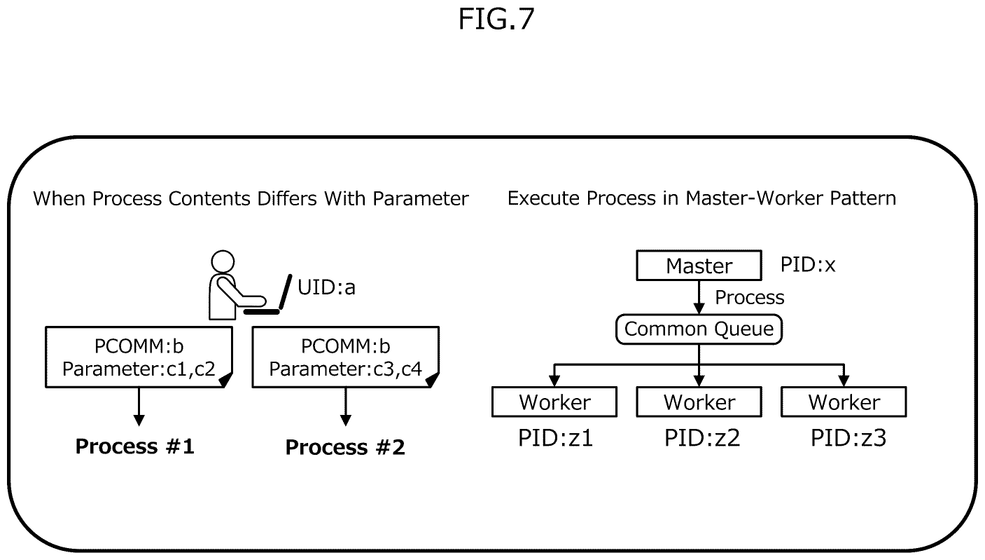

FIG. 7 is a diagram illustrating a manner of process identity determination in a second comparative example. In the second comparative example, each of the multiple processes 4 has a user identification (UID: User ID), a process identification (PID: Process ID), and a process name (PCOMM). The processor determines the identity between the preceding process 4-t and the current process 4-i on the basis of the PIDs, the PCOMMs and the UIDs.

However, as illustrated in the left side of FIG. 7, even when the multiple processes 4 have the same UID and PCOMM, different processes may be executed as a result of switching the parameters. Accordingly, some cases have difficulty in determining the identity between multiple processes 4 by referring to the UIDs and the PCOMMs.

In contrast, as illustrated on the right side of FIG. 7, when a master-worker pattern is adopted, the master determines the work items to be executed and arranges the items in a common queue. The master monitors the completion status of each item and terminates its own process when all the items are completed. Each of multiple workers (e.g., target servers) extracts a work item from the common queue and executes the corresponding process. In such cases, multiple processes which have respective different PIDs may have identity. This case has difficulty in determining the identity among multiple process 4 by referring to the PIDs. It is desirable that the identity among multiple processes 4 may be determined even when it is difficult to determine the identity between the preceding process 4-t and the current process 4-i on the basis of the PIDs, the PCOMMs, and the UIDs as described above.

### D. Example of Functional Configuration

FIG. 8 is a block diagram illustrating an example of a functional configuration of the target server 100 in the one embodiment. The target server 100 is an example of a computer (information processing apparatus).

As illustrated in FIG. 8, the target server 100 includes the controller 110 and a memory unit 120. The controller 110 includes a related information obtainer 111, a hash value calculator 115, a determiner 116, the selector 117, the measure 118, and a communicator 119.

The memory unit 120 is an example of a storing region and stores various data that the controller 110 uses. The memory unit 120 may be implemented by, for example, a storing region included in one or both of the memory 100b and the storing device 100c illustrated in FIG. 2.

As illustrated in FIG. 8, the memory unit 120 may exemplary be capable of storing the hash table 8 and set information 121. In addition, the memory unit 120 may be capable of storing the results of measuring the multiple pieces of the performance information 5.

The set information 121 may include information such as the number of performance information sets 7 (three of performance information sets #1 to #3 in one example), the types of performance information 5 included in each performance information set 7, and the order in which the performance information sets 7 are measured (in the order of #1, #2, and #3 in one example).

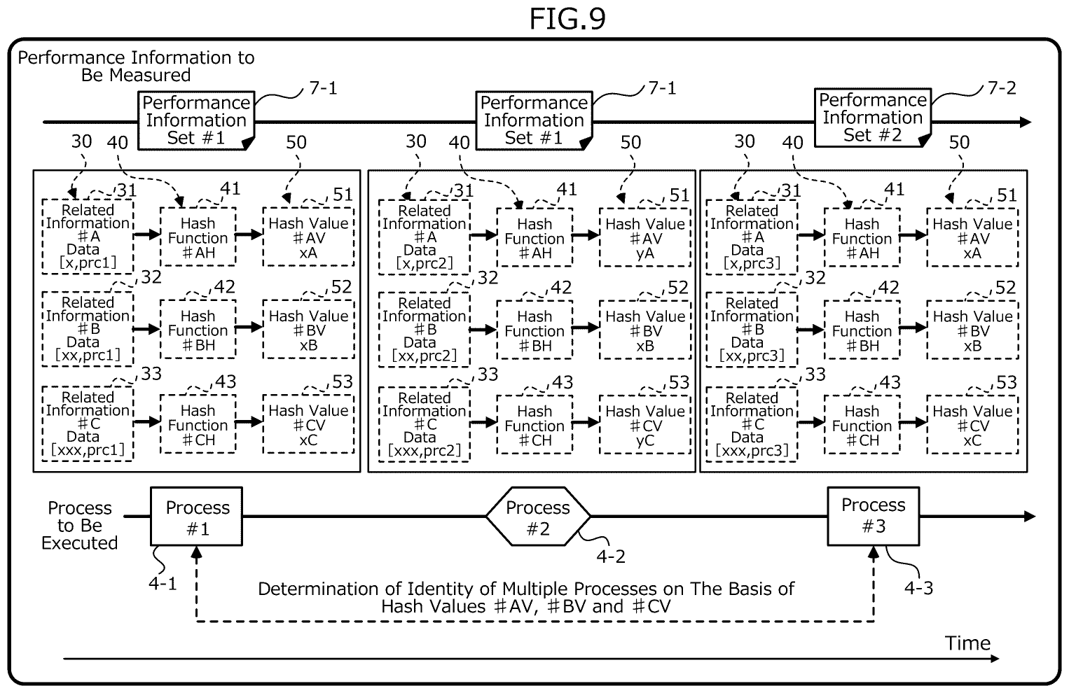

As illustrated in FIG. 9, the hash table 8 includes a hash function 41 (#AH), a hash function 42 (#BH), and a hash function 43 (#CH), which are different from one another, and set for each of the pieces of the related information 31, 32, and 33 (which may be collectively referred to as related information 30), respectively. The hash table 8 includes hash values 51, 52, and 53 calculated for respective multiple processes 4 by inputting values of the related information 31, 32, and 33 into the corresponding hash functions 41, 42, and 43 (which may be collectively referred to as hash functions 40), respectively. The hash values 51, 52, and 53 may be collectively referred to as hash values 50.

FIGS. 9 to 12 illustrate examples of operation of the controller 110. The related information 30 is information related to multiple processes 4, and is information related to determination of the identity among the multiple processes 4.

FIG. 9 is a diagram illustrating an example of a process identity determining process performed by the target server 100 in the one embodiment.

As an example, the related information obtainer 111 may include at least one or all of an environment variable obtainer 112, a memory map obtainer 113, and an execution address obtainer 114.

The related information 30 may include an environment variable, which will be described below. An environment variable may be a variable set for an item such as a job, a task, a processor, or a node in the execution each of the processes 4-1 to 4-3. The environment variable obtainer 112 obtains an environment variable.

The related information 30 may include memory map information, which will be described below. The memory map information is an example of information about memory addresses usable in the execution of each of the processes 4-1 to 4-3. The memory map obtainer 113 obtains the memory map information.

The related information 30 may include an execution address, which will be described below. The execution addresses may be address information used one to execute each of multiple instructions in each process 4. The execution address obtainer 114 obtains the number of times each of a plurality of execution addresses is used.

The hash value calculator 115 calculates the hash values 50 of each of the processes 4-1 to 4-3 by inputting the values of the plurality of pieces of the related information 30 into a corresponding hash function 40.

The determiner 116 compares the hash values 51, 52, and 53 of the preceding processes 4-t (e.g., processes 4-1 and 4-2 in FIG. 9) with the hash values 51, 52, and 53 of the current process 4-i (e.g., process 4-3 in FIG. 9), respectively. The determiner 116 determines whether or not hash values 51, 52, and 53 match among the preceding processes 4-t (processes 4-1 to 4-2 in FIG. 9) and current process 4-i based on the result of the comparison.

The selector 117 selects second performance information that is at least partly different from the first performance information measured while the preceding process 4-t is being executed from among the multiple pieces of performance information 5. The measure 118 measures the selected second performance information while the current process 4-i is being executed. The communicator 119 transmits result of measuring the performance information 5 obtained by the measure 118 to another device such as the collecting server 20.

In FIG. 9, the target server 100 executes multiple process 4 in the order of the processes 4-1 (#1), 4-2 (#2), and 4-3 (#3).

The related information obtainer 111 obtains the values of the one or more pieces of the related information 30 for each of the multiple processes 4. In FIG. 9, in process 4-1, the related information 31, 32, and 33 have values of x and xx, xxx, respectively. In the process 4-2, the related information 31, 32, and 33 have values of y and xx, yyy, respectively. In process 4-3, the related information 31, 32, and 33 have values of x and xx, xxx, respectively. In FIG. 9, prc1, prc2, and prc3 represent the names of the process 4-1, 4-2, and 4-3, respectively.

The hash value calculator 115 calculates hash values 51, 52, and 53 for each of the multiple processes 4 by inputting the respective values of the related information 31, 32, and 33 into the predetermined respective corresponding hash functions 41, 42, and 43, respectively.

For the case of FIG. 9, the values xA, xB, and xC are calculated as the respective hash values 50 of the related information 31, 32, and 33 of the processes 4-1 (prc1), respectively. For the process 4-2 (prc2), the values yA, xB, and yC are calculated as the hash values 50 of the related information 31, 32, and 33 respectively. For the process 4-3 (prc3), the values xA, xB, and xC are calculated as the hash values 50 of the related information 31, 32, and 33, respectively.

In the case of FIG. 9, the hash values 50 (xA, xB, and xC) calculated for the process 4-1 match the hash values 50 (xA, xB, and xC) calculated for the process 4-3.

The determiner 116 determines whether the hash values 50 of the related information 30 for each of one or more preceding processes 4-t (e.g. the process 4-1) match the hash values 50 of the related information 30 of the current process 4-i (e.g., process 4-3). In other words, the determiner 116 determines whether or not the hash values 50 for the preceding process 4-t collide with the hash values 50 for the current process 4-i.

The determiner 116 may perform a process of determining a collision of hash values 50 using, for example, the chain method. Alternatively, the determiner 116 may perform the process of determining a collision of hash values 50 using the open address method instead of the chain method. The method for a determination process used by the determiner 116 is not limited as far as the method involves a technique that determines whether or not the hash values 50 match between the preceding process 4-t and the current process 4-i, that is, whether the hash values 50 of the processes 4-t and 4-i match.

The chain method is a method for solving a collision occurring during data searching in the hashing method, and prepares and manages lists as many as elements that collide at a single position. Accordingly, the hash table 8 is an array of the lists.

The open address method is a method that carries out, when a collision occurs, re-hash to find another vacant storage position by using different means again. Since both the chain method and the open address method may use existing techniques, detailed description thereof will be omitted here.

When the hash values 50 for the preceding process 4-t match the hash values 50 for the current process 4-i, the selector 117 selects the performance information set 7-2 including performance information at least partly different from the performance information set 7-1 (#1) measured while the preceding process 4-t is being executed. While the current process 4-3 is being executed, the measure 118 measures the selected performance information set 7-2 (#2).

Accordingly, the determiner 116 determines the identity between multiple processes 4 on the basis of the hash values 50. Specifically, if the hash values 51 are the same among multiple processes 4, the determiner 116 determines that the related information 31 (#A) is the same among the processes 4. Similarly, if the hash values 52 are the same among the multiple processes 4, the determiner 116 determines that the related information 32 (#B) is the same among the processes 4. Similarly, if the hash values 53 are the same among the multiple processes 4, the determiner 116 determines that the related information 33 (#C) is the same among the processes 4. The number of multiple processes 4 and the number of multiple pieces of related information 30 are not limited to those in FIG. 9.

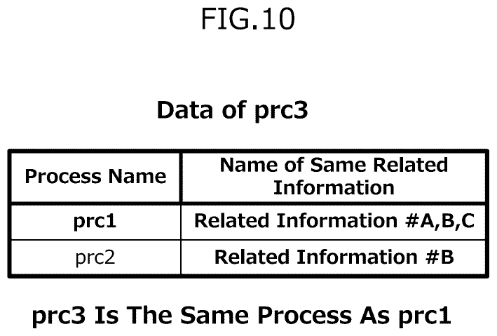

FIG. 10 is a diagram illustrating an example of a result of the process identity determination. The determiner 116 determines that the related information #A, #B, and #C for the process 4-3 having a process name prc3 are the same as the related information #A, #B, and #C for the preceding process 4-1 having a process name prc1. On the other hand, the determiner 116 determines that the related information #B for process 4-3 having a process name prc3 is the same as the related information #B for the preceding process 4-2 having a process name prc2, but the related information #A and #C are not the same between the process 4-3 and the process 4-2. Consequently, the determiner 116 determines that the process 4-3 having a process name prc3 has identity with the preceding process 4-1 having a process name prc1, but does not have identity with the preceding process 4-2 having a process name prc2.

Having “identity” among multiple processes 4 may be satisfied by a case where at least some of hash values 51, 52, and 53 calculated for the predetermined related information #A, #B, and #C are common among the multiple processes 4. Alternatively, the determiner 116 may determine that multiple process 4 are the same (i.e., having identity) when the items of all the related information 31, 32, and 33 are the same among the multiple process 4, that is, when all the hash values 51, 52, and 53 are the same among the multiple processes 4.

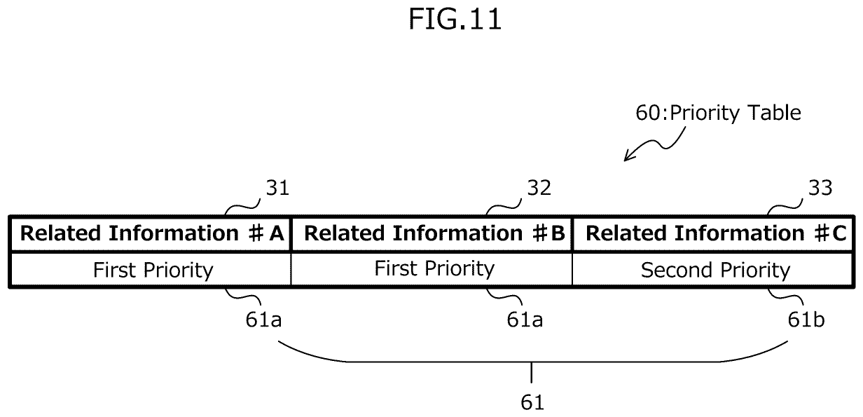

FIG. 11 is a diagram illustrating an example of a priority table that define priorities (preferences) of the related information #A, #B, and #C. In FIG. 11, priorities 61 are set one for each of the pieces of the related information 31 (#A), 32 (#B), and 33 (#C). In FIG. 11, a first priority 61a is defined for the related information 31 (#A) and 32 (#B), and a second priority 61b is defined for the related information 33 (#C). The priority level of the first priority 61a is higher than the priority level of the second priority 61b.

In cases where the first priority 61a is defined as a reference in FIG. 11, when the hash values 51 and 52 of the related information 31 and 32 having a same priority as or higher than the reference are common between multiple processes 4, the determiner 116 may determine that the multiple process 4 have identity. In this case, the determiner 116 may omit comparing hash values 53 of the remaining pieces of the related information among the multiple process 4.

A case where the multiple processes 4 have “identity” may include a situation where another additional information may be different between the multiple processes 4. Accordingly, “identity” may be referred to as similarity or commonality.

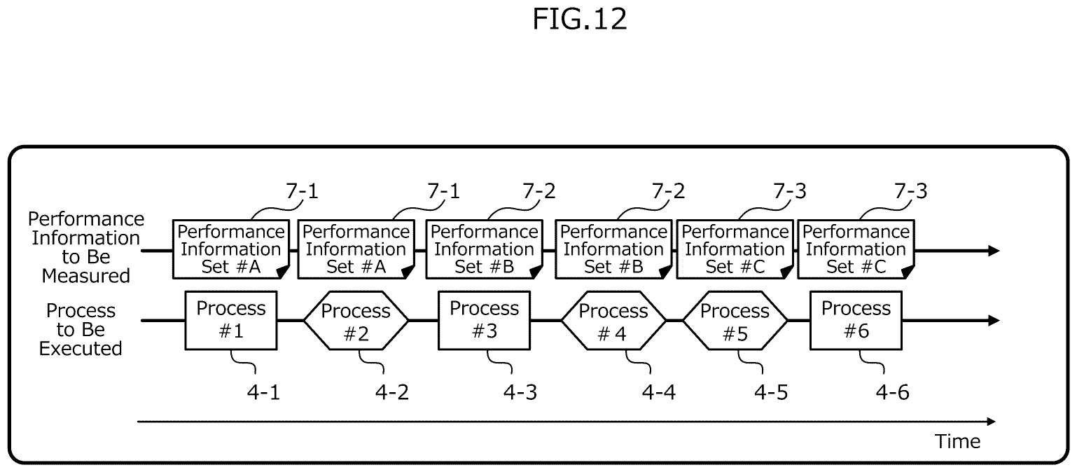

FIG. 12 is a diagram illustrating an example of a measuring process of the performance information 5 performed by the target server 100 in the one embodiment. In FIG. 12, the process 4-1, 4-3, and 4-6 are determined to be process 4 having identity with one another on the basis of the hash values 50. Process 4-1, 4-3, and 4-6 having identity with one another are represented by the shapes of the (rectangular) frames in FIG. 12.

In the target server 100 of the present embodiment, the measure 118 may be exempt from completing measurement of all the multiple pieces of performance information 5 while executing one process 4 (for example, process 4-1). The measure 118 measures multiple pieces of performance information 5 dispersedly while multiple processes 4 (e.g., process 4-1 and 4-3) having identity are being executed. In FIG. 12, among the multiple pieces of performance information 5, the performance information set 7-1 (performance information 5-1 to 5-4 in FIG. 5 in one example) is measured while the process 4-1 is being executed. Among the multiple pieces of performance information 5, the performance information set 7-2 (performance information 5-5 to 5-8 in FIG. 5 in one example) is measured while the process 4-3 is being executed. The performance information set 7-3 (performance information 5-9 to 5-12 in FIG. 5 in one example) is measured while the process 4-6 is being executed.

When the number of processes 4 having identity increases, the number of pieces of the performance information 5 to be measured may be increased. Without increasing the number of types of performance information 5 to be measured while a single process is being executed, the number of types of performance information 5 that may achieve a detailed system performance measurement may be measured.

The number of types of performance information 5 included in each performance information set 7 may be different or same with the respective performance information sets 7. The number of types of performance information 5 included in each performance information set 7 is preferably the counter number or less. When the number of types of performance information 5 included in each performance information set 7 is the counter number or less, there is no need to switch performance information 5 to be measured during a single process, so that it is possible to avoid degradation of the measurement accuracy.

### D-1. First Example of Identity Determination of Processes 4

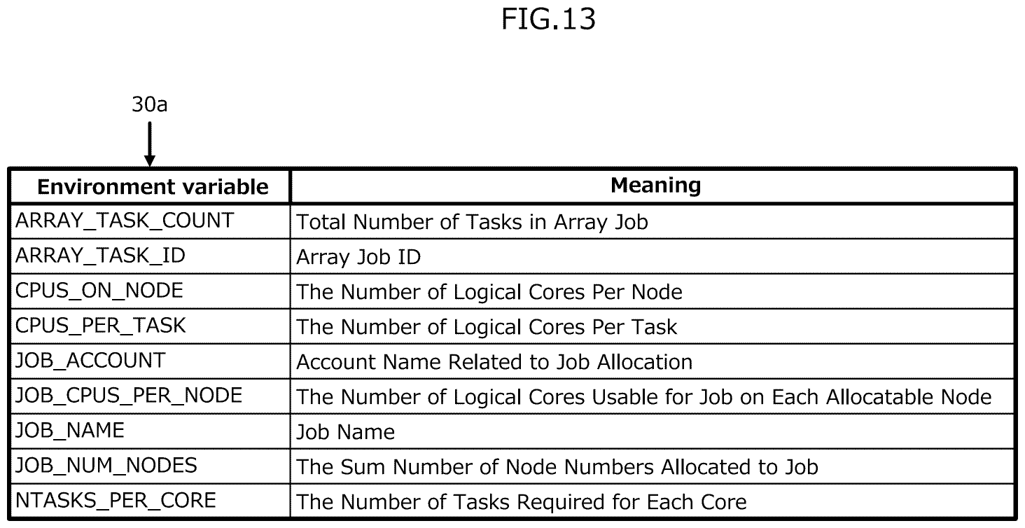

FIG. 13 is a diagram illustrating a first example that uses an environment variable 30a as the related information 30. FIG. 13 is a diagram illustrating environment variables 30a and indicates the environment variables 30a and the meanings thereof in association with each other. In the first example, the environment variable obtainer 112 obtains, as an example of the value of the related information 30 (31, 32, and 33), the values of the environment variables (environment variable names) 30a. The environment variables 30a listed in FIG. 13 are examples. The number and the contents of the environment variables 30a are not limited. Items of the environment variables 30a may be predetermined. The determiner 116 may determine that, when the environment variable 30a of processes obtained from the job scheduler 10 is different, the processes are different.

An environment variable 30a may be a variable set for at least one of job, task, processor, and node. Since the environment variable 30a is known in the art, detailed description thereof will be omitted.

The environment variable obtainer 112 may obtain an environment variable 30a from the job scheduler 10 (e.g., Slurm Workload Manager).

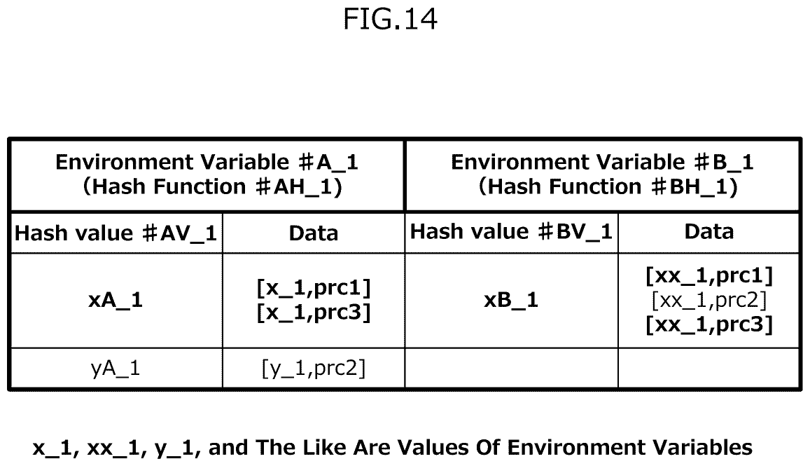

FIG. 14 is a diagram illustrating a result of calculating a hash value 50 in the first example. In FIG. 14, as an environment variable 30a, an environment variable #A_1 and an environment variable #B_1 are given. A hash function #AH_1 is set as the hash function 40 associated with the environment variable #A_1, and a hash function #BH_1 is set as the hash function 40 associated with the environment variable #B_1.

For the process 4-1 (process name prc1), the values of the environment variable #A_1 and environment variable #B_1 are x_1 and xx_1, respectively. The environment variable obtainer 112 obtains the values of the environment variable #A_1 and the environment variable #B_1.

The hash value calculator 115 calculates the values xA_1 and xB_1 as #AV_1 and the #BV_1 serving as the hash values 50 by inputting the values of the environment variable #A_1 and the environment variable #B_1 into the #AH_1 and the #BH_1 serving as the hash functions 40, respectively. The hash value calculator 115 calculates xA_1 and xB_1 as the hash values 50 for the process 4-3 (process name prc3) in the same manner.

In a subsequent process 4-3 (prc3), the determiner 116 refers to the array positions indicated by xA and xB being the calculated hash values 50, and detects that environment variables 30a of the preceding process 4-1 have been assigned to the same array positions. In other words, the determiner 116 determines that hash values 50 are colliding. The collision of hash values 50 means that the hash values 50 (xA_1, xB_1) calculated for the preceding process 4-1 (prc1) match the hash values 50 (xA_1, xB_1) calculated for the subsequent process 4-3 (prc3), respectively. In this case determiner 116 determines that the preceding process 4-1 (prc1) and the subsequent process 4-3 (prc3) are the same.

On the other hand, the hash values 50 (yA_1, xB_1) calculated for the preceding process 4-2 (prc2) do not match the hash values 50 (xA_1, xB_1) calculated for the subsequent process 4-3 (prc3). In this case, the determiner 116 determines that the preceding process 4-2 (prc2) and the subsequent process 4-3 (prc3) are different from each other.

### D-2. Second Example of Identity Determination of Processes 4

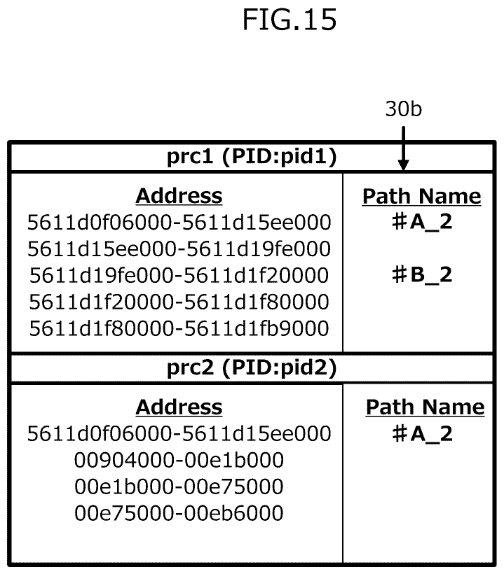

FIG. 15 is a diagram illustrating an example of the related information 30 used in the second example of the identity determination of processes 4. In the second example, the memory map obtainer 113 obtains, as an example of the values of related information 30 (31, 32, 33), the values of memory map information 30b. The memory map information 30b is an example of information about memory addresses that are useable while each process 4 is being executed, and may be information about virtual address space information. The determiner 116 may determine that multiple processes 4 different in the memory map information 30b are not the same process.

The values of the memory map information 30b are given as the value of a memory address that are useable for each path (path name). A path is a character string indicating the location of a particular resource in a computer, and may be a file path in an example.

In one example, the memory map obtainer 113 obtains a PID (process identification). For example, the memory map obtainer 113 obtains the memory map information 30b by reading a maps file from a proc directory according to the PID using a procfs (Process Filesystem).

Here, the memory map obtainer 113 may obtain a UID that has executed an exec( ) system call in the respective process 4 by tracing the kernel with a toolkit using an extended BPF (Berkeley Packet Filter).

A path name (path) of a mapped file is used as an item of the memory map information 30b. A mapping address is used as a value of the memory map information 30b. The mapping address may include a start address and an end address.

In FIG. 15, for the process 4-1 (process name prc1) having a PID of pid1, the items of the memory map information 30b are the path name #A_2 and the path name #B_2, and the value of the memory map information 30b is respective mapping addresses. For the process 4-2 (process name prc2) having a PID of pid2, the item of the memory map information 30b is the path name #A_2, and the value of the memory map information 30b is the mapping address associated with the path name #A_2.

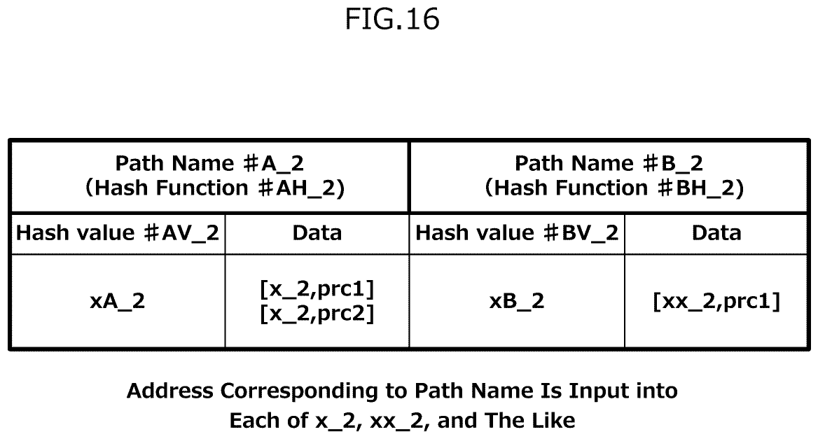

FIG. 16 is a diagram illustrating a result of calculating a hash value 50 in the second example. A hash function #AH_2 is set as the hash function 40 associated with the path name #A_2, and a hash function #BH_2 is set as the hash function 40 associated with the path name #B_2.

For the process 4-1 (process name prc1), the addresses of the path name #A_2 and the path name #B_2 are x_2 and xx_2, respectively. The memory map obtainer 113 obtains addresses having the path name #A_2 and the path name #B_2. The address may be at least one of a start address and an end address of the mapping. The address corresponds to the value of the related information 30.

The hash value calculator 115 calculates the values xA_2 and xB_2 as #AV_2 and the #BV_2 serving as the hash values 50 by inputting the address of the path name #A_1 and the address of the path name #B_1 into the #AH_2 and the #BH_2 serving as the hash functions 40, respectively.

On the other hand, for the subsequent process 4-2 (process name prc2), the address of the path name #A_2 is x_2, but the address of the path name #B_2 does not exist. The memory map obtainer 113 obtains the address of the path name #A_2, and obtains information indicating that the addresses of the path name #B_2 do not exist.

In FIG. 16, since the respective addresses of the path name #B_2 do not exist in the process 4-2 (process name prc2), the #BV_2 serving as a hash value 50 does not exist. Also in this case, the hash value 50 calculated for the preceding process 4-1 (prc1) may be determined not to match the hash value 50 calculated for the subsequent process 4-2 (prc2). The determiner 116 determines that the preceding process 4-1 (prc1) and the subsequent process 4-2 (prc2) are different from each other.

### D-3. Third Example of Identity Determination of Processes 4

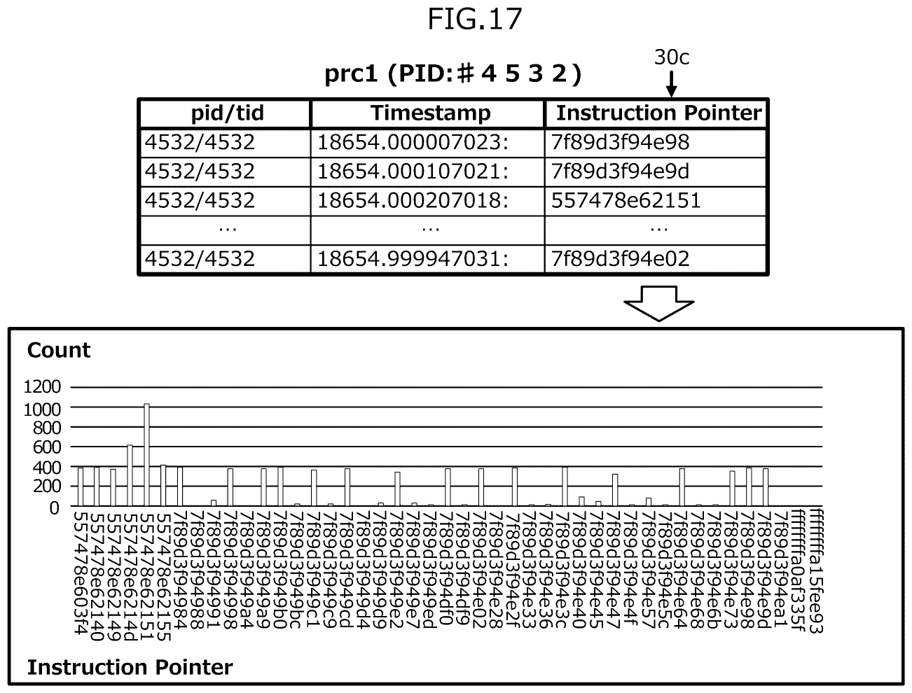

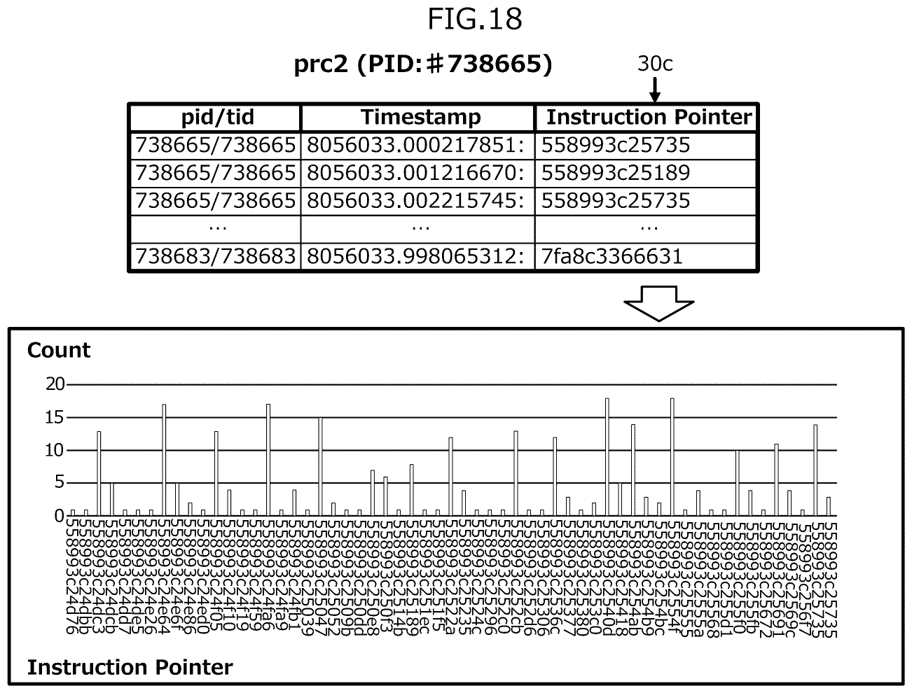

FIGS. 17 and 18 are diagrams illustrating a third example that uses the number of times each execution address 30c is used as a value of the related information 30. FIG. 17 illustrates an example of the number of times an execution address 30c of the process 4-1 (prc1) having a PID #4532 is used. FIG. 18 illustrates an example of the number of times an execution address 30c of the process 4-(prc2) having a PID #738665 is used. The example of related information 30 for the process 4-3 (prc3) will be omitted here, but is the same as that illustrated in FIG. 17.

In the third example, the execution address obtainer 114 obtains the number of times the execution address 30 serving as an example of the related information 30 (31, 32, 33) is used. The determiner 116 may determine that, when the number of times the execution address 30 is different among the multiple processes 4, the multiple processes 4 are not the same process. The number of times the execution address 30c is executed includes a value based on the number of times of using, such as a using frequency.

The execution address 30c may be address information used to execute each instruction in each process 4. In this example, the execution address 30c is an instruction pointer that points the address to be executed next.

The execution address obtainer 114 obtains an instruction pointer to be used. The execution address obtainer 114 may obtain an instruction pointer using a technique such as Linux perf (Performance analysis tools for Linux®) or BPF (Berkeley Packet Filter) trace. An instruction pointer may be obtained by any existing technique, so detailed description thereof is omitted here. The execution address obtainer 114 sums the number of times each of the instruction pointers to be used in each process.

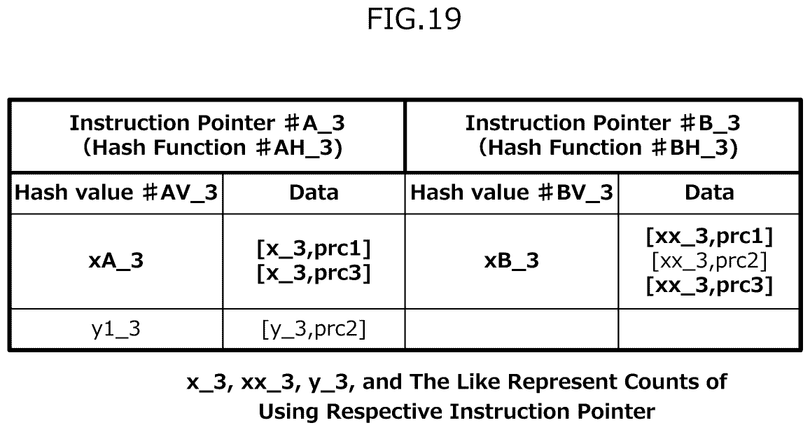

FIG. 19 is a diagram illustrating a result of calculating a hash value 50 in the third example. In FIG. 19, an instruction pointer #A_3 and an instruction pointer #B_3 are given as the execution addresses 30c. A hash function #AH_3 is set as the hash function 40 associated with the instruction pointer #A_3, and a hash function #BH_3 is set as the hash function 40 associated with the instruction pointer #B_3.

For the process 4-1 (process name prc1), the number of times the instruction pointer #A_3 is used and the number of times the instruction pointer #B_3 is used are x_3 and xx_3, respectively. The execution address obtainer 114 obtains the number of times the instruction pointer #A_3 is used and the number of times the instruction pointer #B_3 is used.

The hash value calculator 115 inputs the values of the number of times the instruction pointer #A_3 is used and the number of times the instruction pointer #B_3 is used, into #AH_3 and the #BH_3 serving as the hash functions 40, respectively. Consequently, the hash value calculator 115 calculates xA_3 and xB_3 as the #AV_3 and the #BV_3 serving as the hash values 50. The hash value calculator 115 calculates xA_3 and xB_3 as the hash values 50 in the process 4-3 (process naming prc3) in the same manner.

In a subsequent process 4-3 (prc3), the determiner 116 refers to the array positions indicated by xA and xB being the calculated hash values 50, and detects that execution addresses 30c of the preceding process 4-1 have been assigned to the same array positions. In other words, the determiner 116 determines that hash values 50 are colliding. The collision of hash values 50 means that the hash values 50 (xA_3, xB_3) calculated for the preceding process 4-1 (prc1) match the hash values 50 (xA_3, xB_3) calculated for the subsequent process 4-3 (prc3), respectively. In this case determiner 116 determines that the preceding process 4-1 (prc1) and the subsequent process 4-3 (prc3) are the same.

On the other hand, the hash values 50 (yA_3, xB_3) calculated for the preceding process 4-2 (prc2) do not match the hash values 50 (xA_3, xB_3) calculated for the subsequent process 4-3 (prc3). In this case, the determiner 116 determines that the preceding process 4-2 (prc2) and the subsequent process 4-3 (prc3) are different from each other.

The related information 30 illustrated in FIGS. 13 to 19 is exemplary. The related information 30 may include at least one of the environment variable 30a, the memory map information 30b, and the execution address 30c. The related information 30 may include all the environment variable 30a, the memory map information 30b, and the execution address 30c. Furthermore, the related information 30 is not limited to the environment variable 30a, the memory map information 30b, and the execution address 30c. Alternatively, the related information 30 may be a CPI (Cycles Per Instruction) that is an index representing a clock cycle count required per instruction. Since the CPI may be often obtained in any of multiple process 4, a further increased in load may be suppressed.

### E. Example of Operation

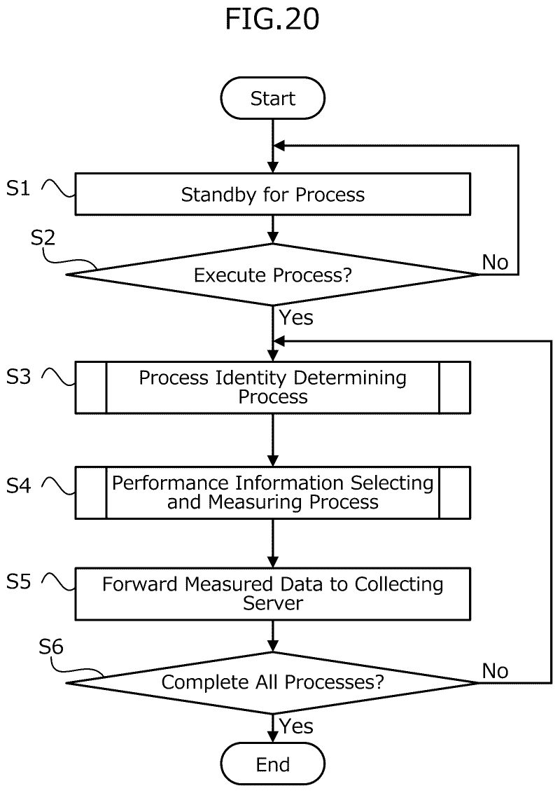

FIG. 20 is a flow chart illustrating an example of operation of a performance information collecting process performed by the target server 100 in the one embodiment.

As illustrated in FIG. 20, when the controller 110 of the target server 100 does not receive an instruction to execute the process 4 (see No route of Step S2), the controller 110 continues to standby for a process (idle state) (Step S1). The process 4 is a computation process. If the process 4 is to be executed (see Yes route in Step S2), the process proceeds to Step S3.

The controller 110 executes a process identity determining process that determines the identity between the current process 4-i and the preceding process 4-t on the basis of the hash values 50 obtained by inputting the values of the obtained related information 30 into the hash functions 40 (Step S3).

The controller 110 obtains the values of the related information 30 obtained for the preceding process 4-t and the current process 4-i. The different hash functions 40 are set for each of the pieces of the related information 30. The controller 110 calculates the hash value 50 for each of multiple process 4 by inputting the value of the related information 30 into the hash function 40.

The controller 110 executes a performance information selecting and measuring process on the basis of the result of determining as to whether or not the hash values 50 for the corresponding related information 30 match among the multiple processes 4 (Step S4). The performance information selecting and measuring process includes a process of selecting performance information 5 to be measured while the current process 4-i is being executed, and a process of measuring of measuring the selected performance information 5. The controller 110 executes a computing process (not illustrated) of the process 4 in parallel with Step S4.

The communicator 119 forwards the measured data of the measured performance information 5 to the collecting server 20 (Step S5).

The controller 110 repeats the process of Steps S3 to S6 for each process 4 until all the processes 4 included in the job 3 are completed (see No route of Step S6). When the controller 110 completes all processes 4 included in the job 3 (see Yes route of Step S6), the process ends. The controller 110 may terminate the process when a forced termination instruction is given before executing all the processes 4 included in the job 3.

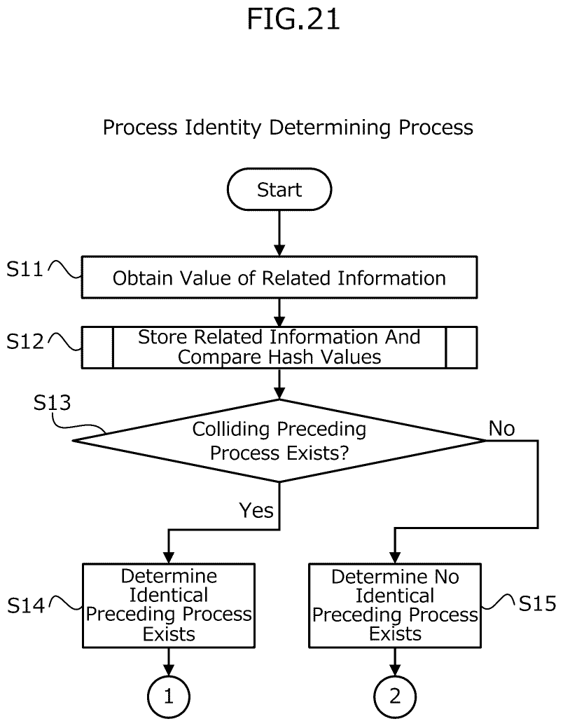

FIG. 21 is a diagram illustrating an example of operation of the process identity determining process performed by the target server 100 in the one embodiment. The flow chart of FIG. 21 is an example of the process of Step S3 of FIG. 20.

The related information obtainer 111 obtains the value of the related information 30 related to each of multiple process 4 executed in the target server 100, which is a target of performance analysis (Step S11).

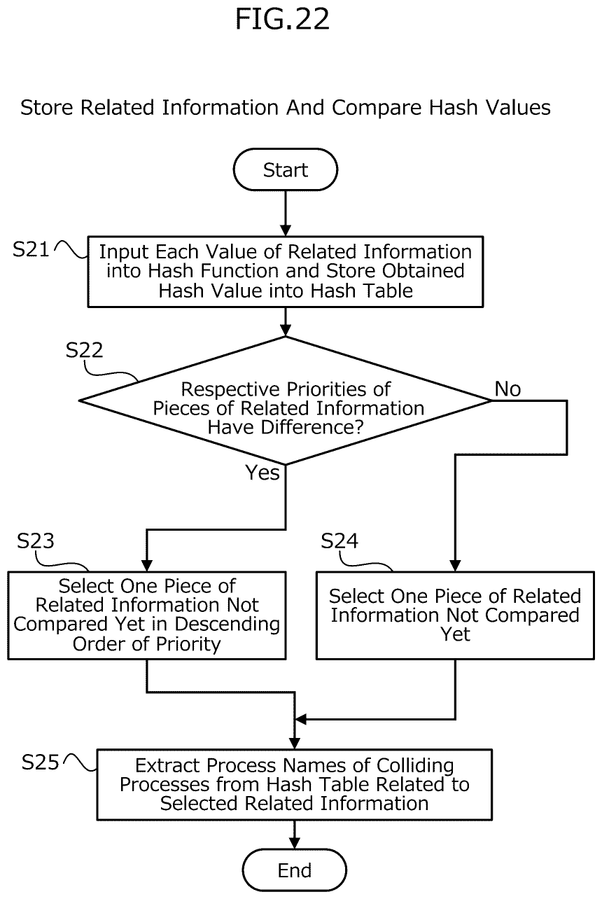

The controller 110 then performs a process for storing the related information 30 and comparing the hash values 50 (Step S12). An example of the process of Step S12 is described with reference to FIG. 22.

FIG. 22 is a diagram illustrating an example of operation of a process of storing the related information 30 and comparing the hash values 50 performed by the target server 100 according to the one embodiment.

The hash value calculator 115 calculates the hash values 50 by inputting the values of the related information 30 into the corresponding hash function 40. The hash value calculator 115 stores the values of the related information 30 into the hash table 8, using the calculated hash values 50 as indices (that is, the positions in the array) (Step S21). The process of Step S21 is an example of a process that calculates hash values 50 for each of the multiple processes 4 to be executed by inputting the values of one or more pieces of the related information 30 associated with the process 4 into the predetermined respective corresponding hash functions 40.

The determiner 116 determines whether the priorities 61 of the one or more pieces of the related information 30 have differences by referring to the priority table 60 (Step S22). If the priorities 61 of the pieces of the related information 30 have differences (Yes route in Step S22), the determiner 116 selects the pieces of the related information 30 in the descending order of the priorities 61 (Step S23). If the priorities 61 of the pieces of the related information 30 have no difference (No route of Step S22), the determiner 116 selects a piece of related information 30 not compared yet (Step S24).

In one example, the determiner 116 may determine whether or not a piece of the related information 30 has been compared by arranging the pieces of the related information 30 into a list and applying a flag to each piece of the related information 30 in the list.

If some pieces of the related information 30 have the same priority 61 but some pieces have different priorities 61 among the multiple pieces of the related information 30, the determiner 116 sorts the multiple pieces of the related information 30 using a scheme of the stable sorting based on the priorities 61. The stable sorting is a sorting scheme that keeps the order of entries having the same value (in this example, the magnitude of the priority 61) unchanged. For example, a situation is exemplified where the priority 61 has two levels of the first priority 61a and the second priority 61b lower in degree than the first priority 61a, and multiple pieces of the related information 30 having the first priority 61a and the related information 30 having the second priority 61b exists. In this case, the determiner 116 selects the multiple pieces of the related information 30 having the first priority 61a. Since the multiple pieces of the related information 30 having the same first priority 61a have no difference in priority 61, the determiner 116 selects a piece of the related information 30 not compared yet according to the order of the stable sorting. When the selection for all of the multiple pieces of the related information 30 having the first priority 61a is completed, the determiner 116 selects multiple pieces of related information 30 having the second priority 61b that is lower by one level than the first priority 61a. Since the multiple pieces of related information 30 having the same second priority 61b have no difference in priority 61, the determiner 116 arbitrarily selects a piece of related information 30 not compared yet according to the order of the stable sorting. If the priority has three or more levels, the determiner 116 may repeat the same process.

The determiner 116 extracts process names of the processes 4 the hash values of which are colliding with each other from the hash table 8 associated with the selected piece of the related information 30 (Step S25).

In one example, the determiner 116 determines whether a collision of hash values 50 has occurred in the hash table 8 associated with the selected piece of the related information 30. In other words, the determiner 116 may determine, for each piece of the related information 30, whether or not hash values 50 calculated by inputting the values of the pieces of related information 30 into the hash functions 40 are the same among the multiple processes 4.

The process returns to Step S13 in FIG. 21. In Step S13, the determiner 116 determines whether or not a preceding process 4-t having a hash value 50 colliding with the hash value 50 of the current process 4-i exist. In other words, the determiner 116 determines whether or not a preceding process 4-t having a hash value 50 matching the hash value 50 of the current process 4-i exist.

If a preceding process 4-t having a hash value 50 colliding with the hash value 50 of the current process 4-i exists (see Yes route of Step S13), the determiner 116 determines that the preceding process 4-t and the current process 4-i have identity with each other (Step S14). If no preceding process 4-t having a hash value 50 colliding with the hash value 50 of the current process 4-i exists (see No route of Step S13), the determiner 116 determines that the preceding processes 4-t do not have identity with the current process 4-i (Step S15).

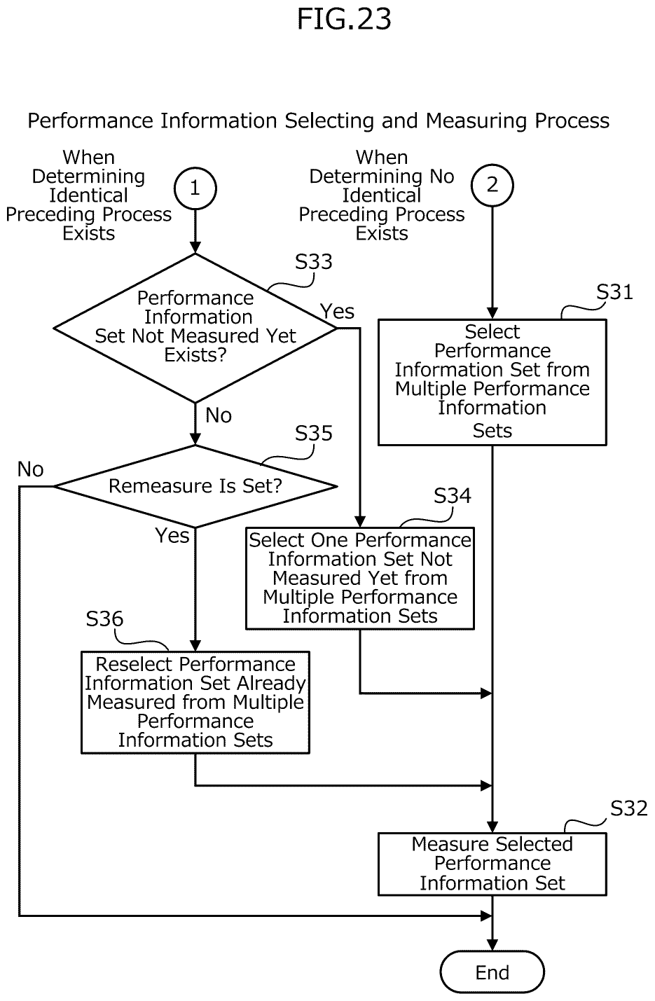

FIG. 23 is a flow chart illustrating an example of operation of a performance information selecting and measuring process performed by the target server 100 in the one embodiment. The flow chart of FIG. 23 is an example of the process of Step S4 of FIG. 20.

If no preceding process 4-t having identity with the current process 4-i exists, the processes of Step S31 and Step S32 are executed and then the process ends.

The selector 117 selects one performance information set 7-1 (e.g., #1) from multiple performance information sets 7 (#1, #2, #3) (Step S31). Specifically, if the determiner 116 determines that the current process 4-i and preceding process 4-t do not have identity with each other, the selector 117 selects a performance information set 7-1 (#1), which is the first in the order, with reference to the set information 121.

The measure 118 measures performance information 5 included in multiple performance information sets 7 selected by the selector 117 while the current process 4-i is being executed (Step S32), and them the process ends.

If a preceding process 4-t having identity with the current process 4-i exists, the processes of Step S33 to Step S36 and the process of Step S32 are executed.

The selector 117 determines whether or not there is a performance information set 7 not measured yet (Step S33). If a performance information set 7 (e.g., #2, #3) including one or more pieces of the performance information 5 not measured yet while the preceding process 4-t is being executed exists (see Yes route in Step S33), the selector 117 proceeds to Step S34.

The selector 117 selects one performance information set 7 (for example, #2) not measured yet from the multiple performance information sets 7 (Step S34). Specifically, if multiple performance information sets 7 (e.g., #2, #3) that have not been measured yet exist, the selector 117 may select the performance information set 7 (e.g., #2) on the basis of information about the order in the set information 121.

If the selector 117 determines that no performance information set 7 not measured yet exists (see No route in Step S33), the process proceeds to Step S35. The selector 117 confirms whether or not remeasure is set (Step S35). The setting of the remeasure means setting in which the performance information 5 (i.e., the first performance information) already measured is to be remeasured while the current process 4-i is being executed, and may be set by an instruction of the user.

If remeasure is set (Yes route of Step S35), the selector 117 reselects the performance information sets 7 (e.g., #1) already measured from the multiple performance information sets 7 (e.g., #1, #2, #3) (Step S36). The measure 118 measures performance information 5 included in the reselected performance information set 7 (e.g., #1) while the current process 4-i being executed (Step S32), and ends the process. That is, the process of Step S36 is an example of a process performed when the hash values 50 calculated for the preceding process 4-t and the current process 4-i match and all pieces of performance information different from the first performance information among multiple pieces of the performance information are already measured. In this case, while the current process 4-i is being executed, the measure 118 re-measures the first performance information that has already been measured.

On the other hand, if remeasure is not set (No route of Step S35), the measure 118 ends the process without measuring the performance information 5 while the current process 4-i is being executed. Not measuring the performance information 5 while the current process 4-i is being executed is an example of suppressing the measurement of the performance information 5 while the current process 4-i is being executed.

The process illustrated in FIG. 23 may reduce the measurement overhead and communication overhead in the target server 100 during the performance information selecting and measuring process (Step S4) and the ensuing Step S5 in FIG. 20.

The method for collecting performance information according to the one embodiment is described as above. However, the present embodiment is not limited to the above description, and various modifications may be suggested. For example, the functional blocks included in target server 100 may be merged in any combination or may be divided.

With reference to FIG. 12, a case where multiple processes 4 are executed in series has been described as an example. The current process 4-i and the preceding process 4-t that are targets for determining whether the hash values 50 obtained from values of the related information 30 thereof match may be processes 4 in a parallel process. Accordingly, the method of the one embodiment may also be applied to a manner in which respective processes 4 are performed in parallel.

In addition, the target server 100 may have a configuration (system) that achieves the processing functions by multiple apparatuses cooperating with each other via a network. As one example, the memory unit 120 may be a DB server, and the blocks 111-119 may be each a Web server or an application server.

### F. Effect of One Embodiment

According to the scheme of one embodiment, the target server 100 obtains one or more pieces of related information related to each of multiple processes to be executed in the target server 100. The target server 100 calculates one or more hash values 50 of each of the multiple processes 4 by inputting each of one or more values of one or more pieces of the related information 30 obtained for the process into a hash function 40. When the hash values 50 calculated for the preceding process 4-t and the current process 4-i included in the multiple process 4 at least partially match, the target server 100 measures the second performance information while the current process 4-i is being executed. The second performance information is performance information 5 that is at least partly different from the first performance information measured while the preceding process 4-t is being executed among the multiple pieces of performance information 5.

This makes it possible to measure separately from each other the first performance information and the second performance information included in the multiple pieces of performance information 5 while the multiple processes 4 hash values 50 of which match are being executed. For example, the first performance information is the performance information set 7-1 (#1) and the second performance information is the performance information set 7-2 (#2). The concentration of the measurement process is abated as compared with the case where the entire performance information 5 are measured up to the upper limit of the counter value during a single process 4. As a result, the measurement overhead is reduced, so that the measurement load may be reduced. Furthermore, the CPU usage rate in the measurement process may be reduced.

The communicator 119 may transmit result of the measuring the performance information 5 obtained by the measure 118 to the collecting server 20 sequentially in the order of the measurement. This may abate the concentration of the process of transmitting the result of measuring the performance information 5. The measurement overhead is reduced, so that the measurement load may be reduced. Since the amount of communication between the collecting server 20 and each target server 100 may be reduced, congestion of a communication line may be reduced and the communication rate may be enhanced.

The number of types of performance information 5 included in the first performance information may be set to the counter number or less, and the number of types of performance information 5 included in the second performance information may also be set to the counter number or less. As compared with a case where performance information 5 to be measured is switched in a single process 4, time for measuring the performance information 5 may be further ensured. Therefore, even when the number of types of performance information 5 is increased, lowering the measurement accuracy may be avoided. The number of types of performance information 5 is increased with ease, so that detailed system performance analysis may be accomplished.

In particular, since the identity between multiple processes 4 may be easily determined by using the hash functions 40, it is possible to suppress generation of new overhead.

In particular, even when it is difficult to determine the identity between the preceding process 4-t and the current process 4-i on the basis of the PIDs, the PCOMMs or the UIDs, the identity between the preceding process 4-t and the current process 4-i may be determined based on the hash values 50. Accordingly, the performance information 5 may be dispersedly measured while multiple processes 4 having identity are being executed.

For multiple pieces of the related information 30, different hash functions 40 are set one for each of the pieces of the related information 30.

This makes it possible to determine the identity between multiple processes 4 according to the collision status of hash values 50 based on hash table 8. Consequently, it is possible to reduce a processing load separately added.

Each target server 100 that is the target of the system performance analysis executes, as a computer, a process such as selection of the performance information 5 described above. When the collecting server 20 (analyzer device) executes a process such as selection of the performance information 5, the amount of communication between the target server 100 and the collecting server 20 is hardly reduced, whereas the scheme of the one embodiment may reduce the amount of communication.

The multiple pieces of related information 30 are set with the respective priorities 61. When the hash values 50 of some pieces of the related information 30 selected according to the priority 61 for the preceding process 4-t match the hash values 50 of the same pieces of the related information 30 for the current process 4-i, the determiner 116 omits the comparison of the remaining hash values 50. The measure 118 measures the second performance information while the current process is being executed.

As a result, the process of comparing some of the hash values is omitted, so that the processing load may be reduced.

The related information 30 may be environment variables 30a set for a job, a task, a processor, or a node in execution of each process 4.

Accordingly, the determiner 116 may determine the identity between the preceding process 4-t and the current process 4-i on the basis of the hash values 50 calculated by inputting the values of the environment variable 30a that may be obtained from the job scheduler 10 into the hash functions 40. Therefore, the processing time for determining whether or not multiple processes have identity may be shortened, so that the processing load may be reduced.

The related information 30 may be memory map information 30b that is information about one or more memory addresses usable in execution of each process 4.

Accordingly, the determiner 116 may determine the identity between the preceding process 4-t and the current process 4-i on the basis of the hash values 50 calculated by inputting the address values that may be obtained by reading the maps file into the hash function 40. Therefore, the processing time for determining whether or not multiple processes have identity may be shortened, so that the processing load may be reduced.

The related information 30 may be an execution address 30c, which is address information used to execute each instruction during each process 4.

Accordingly, the determiner 116 may determine the identity between the preceding process 4-t and the current process 4-i on the basis of the hash values 50 calculated by inputting the number of times each execution address that may be obtained via, for example, Linux perf trace into the hash function 40. Therefore, the processing time for determining whether or not multiple processes have identity may be shortened, so that the processing load may be reduced.

The actions and effects of the present embodiment being used in assumable business scenes are capability of executing a system performance analysis while reducing measurement and communication loads of the performance information 5, so that the present embodiment may be applied to various fields pursing significant computing power to process an enormous amount of data. In particular, measurement and communication loads may be reduced in a computation process in the fields of quantum simulator field and the high-performance computing, for example.

In one aspect, the present embodiment may reduce the load on an information processing apparatus serving as a target for performance analysis to measure and transmit performance information.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a performance information collecting program for causing a computer to execute a process for collecting performance information, the process comprising:
obtaining one or more pieces of related information related to each of a plurality of processes, including a first process and a second process, to be executed in an information processing apparatus,
calculating one or more hash values of each of the plurality of processes by inputting each of values of the one or more pieces of the related information obtained for each of the plurality of processes into respective corresponding hash functions, and
when the plurality of hash values calculated for the first process at least partially match the plurality of hash values calculated for the second process,
measuring, while the second process is being executed, second performance information at least partly different from first performance information, the first information being measured while the first process is being executed.

2. The non-transitory computer-readable recording medium according to claim 1, wherein
different hash functions are set one for each of the one or more pieces of the related information.

3. The non-transitory computer-readable recording medium according to claim 2, wherein
priorities are set one for each of one or more pieces of the related information, and
the measuring comprises, when hash values of a part of the one or more pieces of the related information selected according to the priorities for the first process match the hash values of the part of the one or more pieces of the related information for the second process, measuring the second performance information while the second process is being executed, omitting comparing hash values of remaining pieces of the related information for the first process and the hash values of the remaining pieces of the related information for the second process.

4. The non-transitory computer-readable recording medium according to claim 1, wherein the related information includes an environment variable set for a job, a task, a processor, or a node used for execution of each of the plurality of processes.

5. The non-transitory computer-readable recording medium according to claim 1, wherein the related information includes information of a memory address usable in execution of each of the plurality of processes.

6. The non-transitory computer-readable recording medium according to claim 1, wherein the related information includes information of the number of times each of a plurality of execution addresses used one for executing each a plurality of instructions while each of the plurality of processes is being executed.

7. The non-transitory computer-readable recording medium according to claim 1, wherein the information processing apparatus is caused to execute, as the computer, the process.

8. The non-transitory computer-readable recording medium according to claim 1, the process further comprising, when one or more of the hash values calculated for the first process at least partially match one or more of the hash values calculated for the second process and all pieces of performance information different from the first performance information among a plurality of pieces of the second performance information are already measured, suppressing measurement of the plurality pieces of second performance information while the second process is being executed.

9. The non-transitory computer-readable recording medium according to claim 1, wherein the process further comprising, when one or more the hash values calculated for the first process at least partially match one or more the hash values calculated for the second process and all pieces of performance information different from the first performance information among a plurality of pieces of the second performance information are already measured, remeasuring the first performance information while the second process is being executed.

10. A computer-implemented method for collecting performance information comprising:
obtaining one or more pieces of related information related to each of a plurality of processes, including a first process and a second process, to be executed in an information processing apparatus,
calculating one or more hash values of each of the plurality of processes by inputting each of values of the one or more of pieces of the related information obtained for each of the plurality of processes into respective corresponding hash functions, and
when the plurality of hash values calculated for the first process at least partially match the plurality of hash values calculated for the second process,
measuring, while the second process is being executed, second performance information at least partly different from first performance information, the first information being measured while the first process is being executed.

11. The computer-implemented method according to claim 10, wherein
different hash functions are set one for each of the one or more pieces of the related information.

12. The computer-implemented method according to claim 11, wherein priorities are set one for each of one or more pieces of the related information, and
the measuring comprises, when hash values of a part of the one or more pieces of the related information selected according to the priorities for the first process match the hash values of the part of the one or more pieces of the related information for the second process, measuring the second performance information while the second process is being executed, omitting comparing hash values of remaining pieces of the related information for the first process and the hash values of the remaining pieces of the related information for the second process.

13. The computer-implemented method according to claim 10, wherein the related information includes an environment variable set for a job, a task, a processor, or a node used for execution of each of the plurality of processes.

14. The computer-implemented method according to claim 10, wherein the related information includes information of a memory address usable in execution of each of the plurality of processes.

15. The computer-implemented method according to claim 10, wherein the related information includes information of the number of times each of a plurality of execution addresses used one for executing each a plurality of instructions while each of the plurality of processes is being executed.

16. The computer-implemented method according to claim 10, further comprising, when one or more of the hash values calculated for the first process at least partially match one or more of the hash values calculated for the second process and all pieces of performance information different from the first performance information among a plurality of pieces of the second performance information are already measured, suppressing measurement of the plurality pieces of second performance information while the second process is being executed.

17. The computer-implemented method according to claim 10, further comprising,
when one or more the hash values calculated for the first process at least partially match one or more the hash values calculated for the second process and all pieces of performance information different from the first performance information among a plurality of pieces of the second performance information are already measured, remeasuring the first performance information while the second process is being executed.

18. An information processing apparatus comprises
a memory; and
a processor coupled to the memory, the processor being configured to
obtain one or more pieces of related information related to each of a plurality of processes, including a first process and a second process, to be executed in an information processing apparatus,
calculate one or more hash values of each of the plurality of processes by inputting each of values of the one or more pieces of the related information obtained for each of the plurality of processes into respective corresponding hash functions, and
when the plurality of hash values calculated for the first process at least partially match the plurality of hash values calculated for the second process,
measure, while the second process is being executed, second performance information at least partly different from first performance information, the first information being measured while the first process is being executed.

19. The information processing apparatus according to claim 18, wherein
different hash functions are set one for each of the one or more pieces of the related information.

20. The information processing apparatus according to claim 19, wherein
priorities are set one for each of one or more pieces of related information, and
the processor is further configured to,
when hash values of a part of the one or more pieces of the related information selected according to the priorities for the first process match the hash values of the part of the one or more pieces of the related information for the second process, measuring the second performance information while the second process is being executed, omitting comparing hash values of remaining pieces of the related information for the first process and the hash values of the remaining pieces of the related information for the second process.
